(19) United States
(12) Patent Application Publication
(10) Pub. No.: US 2025/0307417 A1
(43) Pub. Date: Oct. 2, 2025

(54) System and method for mitigating vulnerabilities associated with open-source software components in source code

(71) Applicant: Bank of America Corporation, Charlotte, NC (US)

(72) Inventors: David Cuka, West Chicago, IL (US); Irina Shaldervan, Cliffside Park, NJ (US); Bennykutty G. Sebastian, Plainsboro, NJ (US); Rita Lavon Bradley, Fort Mill, SC (US); Joshua Paul Merugu, Telangana (IN); Jipson Jose, Charlotte, NC (US); Koyel Ghosh, Charlotte, NC (US); Peter Tavormina, Hainesport, NJ (US); Christopher Allan Clark, Charlotte, NC (US)

(21) Appl. No.: 18/621,927

(22) Filed: Mar. 29, 2024

(51) Int. Cl. G06F 21/57

(52) U.S. Cl. CPC G06F 21/577; G06F 2221/033

(57) ABSTRACT

A system for mitigating vulnerabilities associated with open-source software components is disclosed. The system receives a request to scan source code for open-source software components. In response, the system scans the source code and determines a software version of the open-source software component in the source code. The system determines a temporal gap factor associated with the open source component and assigns a temporal gap score to the temporal gap factor. The temporal gap score indicates how far behind the software version of the open-source software component is with respect to its latest version. The system determines that temporal gap score is more than a threshold score. In response, the system identifies a most recent version of the open source component that is associated with a less than a threshold number of security vulnerabilities and implements the most recent version of the open source component in the source code.

### TECHNICAL FIELD

The present disclosure relates generally to information security, and more specifically to a system and method for mitigating vulnerabilities associated with open-source software components in source code.

### BACKGROUND

Software developers may utilize open-source code that is available to the public in building software applications. However, utilizing open-source code in an application development task may introduce certain security vulnerabilities, permission issues, and compatibility challenges, among other potential drawbacks.

### SUMMARY

The system described in the present disclosure is particularly integrated into a practical application of improving the open-source software component detection and mitigation techniques in the software development ecosystem. The disclosed system further provides an additional practical application for improving vulnerability detection techniques in software development technology. Software developers may frequently utilize open-source code that is available to the public in building their software applications. However, utilizing open-source code in an application development task may introduce certain vulnerabilities. It is helpful to detect, address, and mitigate such vulnerabilities before they are deployed or pushed into production of the software application associated with the source code.

One potential approach in detecting and assessing vulnerabilities in software code involves cross-referencing portions of the code with the data available in a Common Vulnerabilities and Exposures (CVE) database. However, this approach, when implemented alone, does not provide a robust analysis of the security threats and other drawbacks of implementing the open-source software component in the production of the source code. Similarly, another potential approach involves detecting permission and vulnerability issues associated with the open-source software component. However, this approach, when implemented alone, may not provide accurate information about the overall security threats and other drawbacks of implementing the open-source software component in the production of the source code.

The disclosed system is configured to address these limitations by introducing and detecting a temporal gap factor of the open-source software component to determine an additional dimension in the vulnerability aspect of the open-source software component. The temporal gap factor may indicate how far behind the version of the open-source software component (that is currently in use) is with respect to the latest released version of the open-source software component. The temporal gap factor may indicate how current or outdated the open-source software component may be with respect to its latest released version.

The disclosed system is configured to utilize the permission factor, the vulnerability factor, and the temporal gap factor to improve the software code vulnerability evaluation method and provide a more robust view of the security threats and other drawbacks associated with the open-source software components. This multifaceted approach allows the disclosed system to make more accurate decisions on whether or not to allow the open-source software component to be utilized in the production of the source code. This, in turn, leads the software applications to be both up-to-date and resilient against potential vulnerabilities.

In response to determining that the source code has a total score more than a threshold score, the disclosed system may identify the most recent version of the open-source software component that has fewer vulnerabilities compared to its other versions (e.g., has less than a threshold number of vulnerabilities). In some embodiments, the disclosed system may recommend the user to use the most recent version of the open-source software component that has fewer vulnerabilities. The user may approve or deny the disclosed system's recommendation. In some embodiments, the disclosed system may block utilizing the open-source software component if it is determined that the recommended open-source software component was not approved by the user and the open-source software component does not pass a policy compliance check.

In some embodiments, the disclosed system may issue a warning that indicates using the open-source software component introduces certain vulnerabilities. In some embodiments, the disclosed system may allow the deployment of the open-source software component in the production, if it is determined that the open-source software component passed the policy compliance check.

In this manner, the disclosed system improves the software code vulnerability detection and evaluation techniques in the software development ecosystem, and provides solutions to mitigate the open-source software components. For example, by implementing the disclosed system, vulnerabilities that are undetected by the current techniques may be detected and mitigated. The current techniques do not consider the temporal gap factor associated with open-source software components, and therefore, they may overlook potential security threats and other drawbacks stemming from outdated open-source software components. The introduction of the temporal gap factor, in conjunction with the permission factor and vulnerability factor, enhances systems' ability to provide a robust evaluation of the security threats and other limitations associated with the integration of open-source software components into the production of source code.

In another example, the code scanner may be integrated with the build platform. Therefore, the disclosed system may proactively trigger the scan process when a new code is available in the build platform. In another example, the disclosed system may proactively identify the most recent version of the open-source software component with fewer vulnerabilities (e.g., less than a threshold number of vulnerabilities) in comparison to other versions. This leads to using a more suitable option for the open-source software component.

In some embodiments, the disclosed system integrates the open-source software detection and vulnerability analysis into any software development life cycle process. In this manner, the disclosed system causes open-source software code (and/or library or package) to not be deployed to production unless it has been detected, evaluated, approved, and cataloged. This automatic integration obviates the need for manual review and evaluation, reduces human error, introduces a real-time (or relatively near real-time) up-to-date recording of open-source software components, and improves the vulnerability evaluation and mitigation processes. The disclosed system further assigs ratings to each of the permission, vulnerability, and temporal gap factors associated with the detected open-source software component. This, in turn, provides a better view of the disadvantages and benefits associated with the open-source software components are that intended to be used. The disclosed system may then evaluate the disadvantages associated with the open-source software components and if it is determined that a total threat score of using the open-source software component is more than a threshold value, the disclosed system recommends the most recent version of the open-source software component that is associated with a fewer number of vulnerabilities (e.g., associated with less than a threshold number of vulnerabilities). In this manner, the disclosed system mitigates the detected vulnerabilities associated with the open-source software component.

In some embodiments, the disclosed system may initiate a developer approval operation, to provide the developer the choice to either accept or decline the disclosed system's recommendation. This human-in-the-loop approach allows developers to maintain control over the selection of open-source software components in software developments. Moreover, if the developer opts against using the recommended open-source code and the code does not pass the policy compliance check, the disclosed system may block its utilization and reinforce compliance and security protocols.

In some embodiments, the disclosed system identifies a subset of the source code to be scanned instead of all of the source code. Scanning the source code may be computationally complex and require a lot of processing and memory resources. By identifying a subset of source code to be scanned, processing and memory resources that would be used to scan the whole source code are saved and utilized to process other tasks. The disclosed system may identify a subset of the source code to be scanned that has not been scanned in a past threshold duration (e.g., past two days, past week, and the like).

In some embodiments, the disclosed system may scan a portion of the compiled binary representation of the source code instead of the source code itself. As mentioned above scanning the source code is computationally complex. However, scanning a portion or all of the compiled binary representation of the source code is less computationally intensive. This approach leverages the efficiency of compiled code and is particularly advantageous when a detailed examination of the source code is not required. By focusing on the compiled binary representation, the disclosed system may reduce processing demands, memory usage, and overall processing and memory resource utilization, which provides a more resource-efficient system and method for vulnerability evaluation.

In some embodiments, a system for mitigating vulnerabilities associated with open-source software components in source code comprises a processor and a memory. The memory is configured to store a list of open-source software components. The processor is operably coupled to the memory. The processor is configured to receive a request to determine whether source code comprises any open-source software components, wherein the request comprises information related to a repository where the source code is available. The processor is further configured to determine that a first portion of the source code has not been scanned for a past threshold duration. The processor is further configured to obtain the first portion of the source code from the repository. The processor is further configured to scan the first portion of the source code, wherein scanning the first portion of the source code comprises identifying one or more code patterns associated with an open-source software component from among the list of open-source software components. The processor is further configured to determine, based at least in part upon an identity of the open-source software component, a software version of the open-source software component. The processor is further configured to determine, based at least in part upon the determined software version of the open-source software component, a temporal gap factor associated with the open-source software component, wherein the temporal gap factor indicates how far behind the software version of the open-source software component is with respect to a latest software version of the open-source software component. The processor is further configured to assign a temporal gap risk score to the temporal gap factor, wherein the temporal gap risk score indicates whether a risk of implementing the open-source software component into the source code is more than a first threshold score. The processor is further configured to determine that the assigned temporal gap risk score is more than the first threshold score. In response to determining that the temporal gap risk score is more than the first threshold score, the processor is configured to identify a most recent version of the open-source software component that is associated with a least number of security vulnerabilities and implement the identified most recent version of the open-source software component in the source code.

Some embodiments of this disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an embodiment of a system configured to mitigate vulnerabilities associated with open-source software components in source code;

FIG. 2 illustrates an example operational flow of the system of FIG. 1; and

FIGS. 3A and 3B illustrate an example flowchart of a method to mitigate vulnerabilities associated with open-source software components in source code.

### DETAILED DESCRIPTION

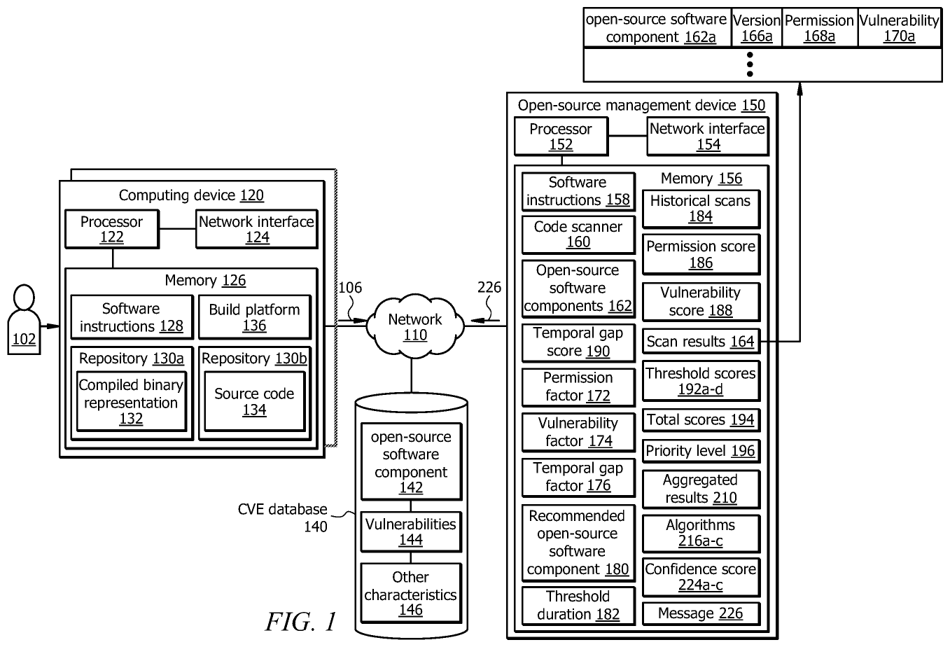

As described above, previous technologies fail to provide efficient and reliable solutions to implement improved security vulnerability evaluations for open-source software components in the software development ecosystem. Embodiments of the present disclosure and its advantages may be understood by referring to FIGS. 1 through 3A-B. FIGS. 1 through 3A-B are used to describe systems and methods to mitigate vulnerabilities associated with open-source software components in source code, according to some embodiments.

### System Overview

FIG. 1 illustrates an embodiment of a system 100 that is generally configured to automatically detect, address, and mitigate vulnerabilities that come with using open-source software code/components. In some embodiments, the system 100 comprises an open-source management device 15 communicatively coupled with computing devices 120, and a common vulnerability and exposure (CVE) database 140 via a network 110. Network 110 enables the communication among the components of the system 100. The users 102 may use the computing devices 120 to develop source code 134 for various software applications. When source code 134 is built at the computing device 120, a request 106 to scan the source code 134 (and/or a compiled binary representation 132 of the source code 134) is sent to the open-source management device 150. The CVE database 140 may include information that may be used by the open-source management device 150 to perform one or more operations described herein. The open-source management device 150 may be configured to scan source code 134 (and/or the compiled binary representation of the source code 134), detect code patterns of open-source software components 142, 162 in the source code 134 (and/or the compiled binary representation of the source code 134), detect characteristics of the open-source software components 162, including permission, vulnerabilities, and temporal gap factors, and mitigate the detected vulnerabilities. These operations are detailed further below. In other embodiments, system 100 may not have all of the components listed and/or may have other elements instead of, or in addition to, those listed above.

In general, the system 100 improves the vulnerability detection techniques in software development technology. Software developers may frequently utilize open-source code that is available to the public in building their software applications. However, utilizing open-source code in an application development task may introduce certain vulnerabilities. It is helpful to detect, address, and mitigate such vulnerabilities before they are deployed or pushed into production of the software application associated with the source code 134.

One potential approach in detecting and assessing vulnerabilities in software code involves cross-referencing portions of the code with the data available in the CVE database 140. However, this approach, when implemented alone, does not provide a robust analysis of the security threats and other drawbacks of implementing the open-source software component in the production of the source code. Similarly, another potential approach involves detecting permission and vulnerability issues associated with the open-source software component. However, this approach, when implemented alone, may not provide accurate information about the overall security threats and other drawbacks of implementing the open-source software component in the production of the source code.

The system 100 is configured to address these limitations by introducing and detecting a temporal gap factor 176 of the open-source software component to determine an additional dimension in the vulnerability aspect of the open-source software component. The temporal gap factor 176 may indicate how far behind the version of the open-source software component (that is currently in use) is with respect to the latest released version of the open-source software component. The temporal gap factor 176 may indicate how current or outdated the open-source software component may be with respect to its latest released version.

The system 100 is configured to utilize the permission factor 172, the vulnerability factor 174, and the temporal gap factor 176 to improve the software code vulnerability evaluation method and provide a more robust view of the security threats and other drawbacks associated with the open-source software components 162. This multifaceted approach allows the system 100 to make more accurate decisions on whether or not to allow the open-source software component 162 to be utilized in the production of the source code 134. This, in turn, leads the software applications to be both up-to-date and resilient against potential vulnerabilities.

In response to determining that the source code 134 has a total score 194, more than a threshold score 192d, the system 100 may identify the most recent version of the open-source software component 162 that has fewer vulnerabilities compared to its other versions (e.g., has less than a threshold number 198 of vulnerabilities). In some embodiments, the system 100 may recommend the user 102 to use the most recent version of the open-source software component 162 that has fewer vulnerabilities. The user 102 may approve or deny the system's recommendation. In some embodiments, the system 100 may block utilizing the open-source software component 162 if it is determined that the recommended open-source software component 180 was not approved by the user 102 and the open-source software component 162 does not pass a policy compliance check.

In some embodiments, the system 100 may issue a warning that indicates using the open-source software component 162 introduces certain vulnerabilities. In some embodiments, the system 100 may allow the deployment of the open-source software component in the production, if it is determined that the open-source software component passed the policy compliance check.

In this manner, the system 100 improves the software code vulnerability detection and evaluation techniques in the software development ecosystem, and provides solutions to mitigate the open-source software components. For example, by implementing the system 100, vulnerabilities that are undetected by the current techniques may be detected and mitigated. The current techniques do not consider the temporal gap factor 176 associated with open-source software components 162, and therefore, they may overlook potential security threats and other drawbacks stemming from outdated open-source software components. The introduction of the temporal gap factor 176, in conjunction with the permission factor 172 and vulnerability factor 174, enhances the systems' ability to provide a robust evaluation of the security threats and other limitations associated with the integration of open-source software components 162 into the production of source code 134.

In another example, the code scanner 160 may be integrated with the build platform 136. Therefore, the system 100 may proactively trigger the scan process when a new code is available in the build platform 136. In another example, the system 100 may proactively identify the most recent version of the open-source software component 162 with fewer vulnerabilities (e.g, less than a threshold number 198 of vulnerabilities) in comparison to its other versions. This leads to using a more suitable option for the open-source software component.

In some embodiments, the system 100 integrates the open-source software detection and vulnerability analysis into any software development life cycle process. In this manner, the system 100 prevents the deployment of open-source software code (and/or library or package) to production unless it has been detected, evaluated, approved, and cataloged. This automatic integration obviates the need for manual review and evaluation, reduces human error, introduces a real-time (or relatively near real-time) up-to-date recording of open-source software components 162, and improves the vulnerability evaluation and mitigation processes. The system 100 further assigs ratings to each of the permission, vulnerability, and temporal gap factors associated with the detected open-source software component 162. This, in turn, provides a better view of the disadvantages and benefits associated with the open-source software components 162 are that intended to be used. The system 100 may then evaluate the disadvantages associated with the open-source software components 162 and if it is determined that a total threat score 194 of using the open-source software component 162 is more than a threshold score 192d, the system 100 recommends the most recent version of the open-source software component 162 that is associated with fewer number of vulnerabilities (e.g., associated with less than a threshold number 198 of vulnerabilities). In this manner, the system 100 mitigates the detected vulnerabilities associated with the open-source software component 162.

In some embodiments, the system 100 may initiate a developer approval operation to provide the developer the choice to either accept or decline the system's recommendation. This human-in-the-loop approach allows developers to maintain control over the selection of open-source software components in software developments. Moreover, if the developer opts against using the recommended open-source code and the code does not pass the policy compliance check, the system 100 may block its utilization and reinforce compliance and security protocols.

In some embodiments, the system 100 identifies a subset of the source code 134 to be scanned instead of all of the source code 134. Scanning the source code 134 may be computationally complex and require a lot of processing and memory resources. By identifying a subset of source code 134 to be scanned, processing and memory resources that would be used to scan the whole source code 134 are saved and utilized to process other tasks. The system 100 may identify a subset of the source code 134 to be scanned that has not been scanned in a past threshold duration 182 (e.g., past two days, past week, and the like).

In some embodiments, the system 100 may scan a portion of the compiled binary representation 132 of the source code 134 instead of the source code 134 itself. As mentioned above, scanning the source code 134 is computationally complex. However, scanning a portion or all of the compiled binary representation 132 of the source code 134 is less computationally intensive. This approach leverages the efficiency of compiled code and is particularly advantageous when a detailed examination of the source code is not required. By focusing on the compiled binary representation, the system 100 may reduce processing demands, memory usage, and overall processing and memory resource utilization, which provides a more resource-efficient system and method for vulnerability evaluation.

### System Components

### Network

Network 110 may be any suitable type of wireless and/or wired network. The network 110 may be connected to the Internet or public network. The network 110 may include all or a portion of an Intranet, a peer-to-peer network, a switched telephone network, a local area network (LAN), a wide area network (WAN), a metropolitan area network (MAN), a personal area network (PAN), a wireless PAN (WPAN), an overlay network, a software-defined network (SDN), a virtual private network (VPN), a mobile telephone network (e.g., cellular networks, such as 4G or 5G), a plain old telephone (POT) network, a wireless data network (e.g., WiFi, WiGig, WiMAX, etc.), a long-term evolution (LTE) network, a universal mobile telecommunications system (UMTS) network, a peer-to-peer (P2P) network, a Bluetooth network, a near-field communication (NFC) network, and/or any other suitable network. The network 110 may be configured to support any suitable type of communication protocol as would be appreciated by one of ordinary skill in the art.

### Example Computing Device

Computing device 120 may be generally any device that is configured to process data and interact with users 102. Examples of the computing device 120 include but are not limited to, a personal computer, a desktop computer, a workstation, a server, a laptop, a tablet computer, a mobile phone (such as a smartphone), smart glasses, Virtual Reality (VR) glasses, a virtual reality device, an augmented reality device, an Internet-of-Things (IoT) device, or any other suitable type of device. The computing device 120 may include a user interface, such as a display, a microphone, a camera, a keypad, or other appropriate terminal equipment usable by user 102. The computing device 120 may include a hardware processor, memory, and/or circuitry configured to perform any of the functions or actions of the computing device 120 described herein.

The computing device 120 includes a processor 122 in signal communication with a network interface 124 and a memory 126. The memory 126 stores software instructions 128 that when executed by the processor 122, cause the processor 122 to perform one or more operations of the computing device 120 described herein. The computing device 120 is configured to communicate with other devices and components of the system 100 via the network 110. The computing device 120 may be associated with the user 102.

The user 102 may use the computing device 120 to perform various operations, such as developing software applications, writing source code 134 for software applications, and engaging in any software development-related activities, among others. In one example, the user 102 may be a software developer associated with an organization to which the open-source management device 150 is associated. The user 102 may initiate the vulnerability evaluation of source code 134 and/or compiled binary representation 132 of the source code 134 from the computing device 120. For example, when a new code is developed/built at the build platform 136, a request 106 may be automatically sent to the open-source management device 150, where the request 106 may include information about where the source code 134 and the compiled binary representation 132 of the source code 134 may be accessed. For example, the request 106 may identify a link or path to the repository 130a where the compiled binary representation 132 of the source code 134 is stored and a link or path to the repository 130b where the source code 134 is stored.

Although, in the example of FIG. 1, the source code 134 and its compiled binary representation 132 are shown to be stored in the memory 126 of the computing device 120. In other examples, the source code 134 and its compiled binary representation 132 may be stored in another remote device and the request 106 may include the links or network paths to those repositories 130a and 130b.

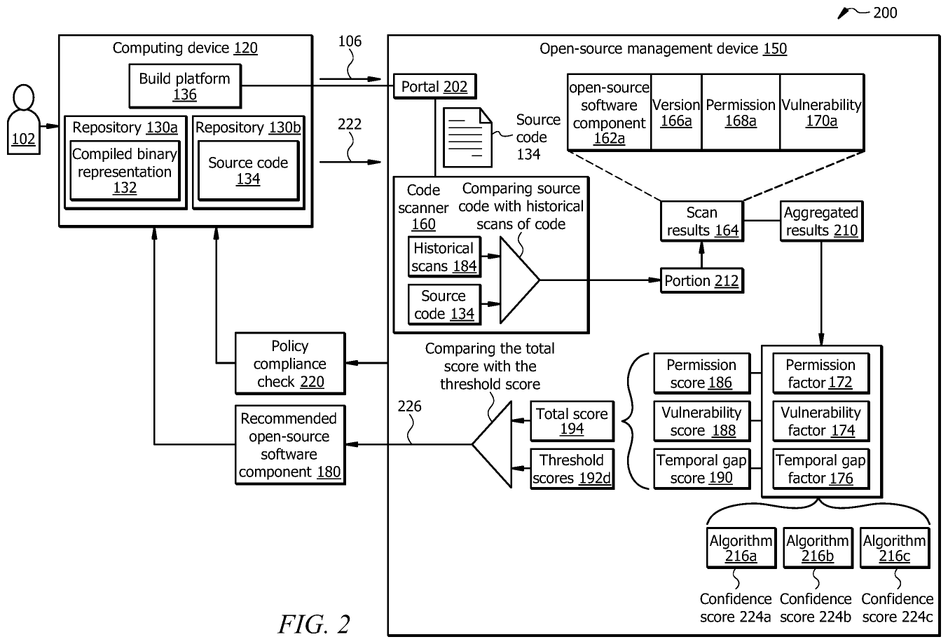

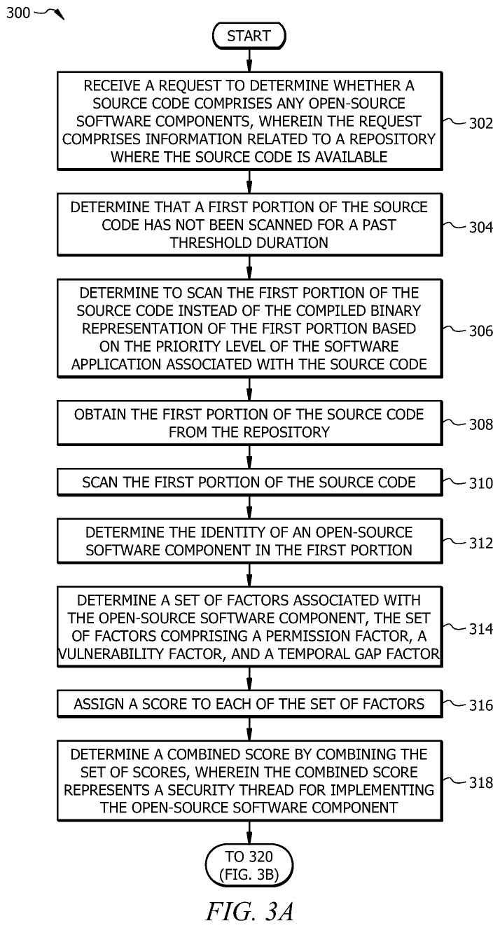

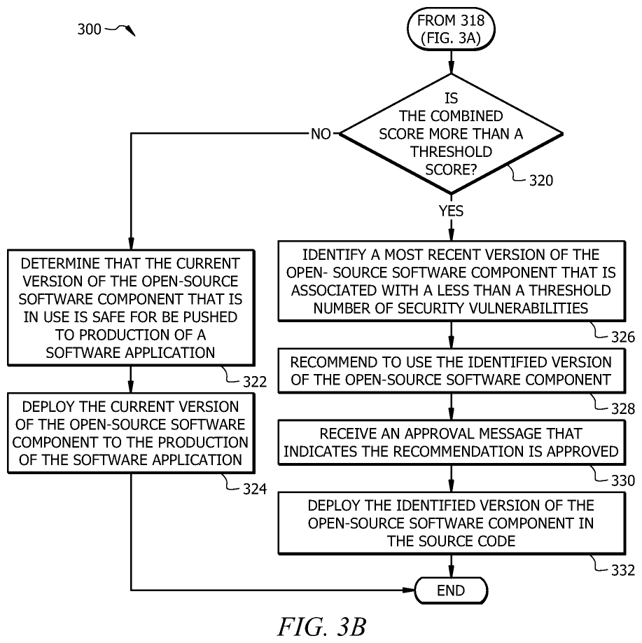

Processor 122 comprises one or more processors. The processor 122 is any electronic circuitry, including, but not limited to, state machines, one or more central processing unit (CPU) chips, logic units, cores (e.g., a multi-core processor), field-programmable gate arrays (FPGAs), application-specific integrated circuits (ASICs), or digital signal processors (DSPs). For example, one or more processors may be implemented in cloud devices, servers, virtual machines, and the like. The processor 122 may be a programmable logic device, a microcontroller, a microprocessor, or any suitable number and combination of the preceding. The one or more processors are configured to process data and may be implemented in hardware or software. For example, the processor 122 may be 8-bit, 16-bit, 32-bit, 64-bit, or of any other suitable architecture. The processor 122 may include an arithmetic logic unit (ALU) for performing arithmetic and logic operations. The processor 122 may register the supply operands to the ALU and store the results of ALU operations. The processor 122 may further include a control unit that fetches instructions from memory and executes them by directing the coordinated operations of the ALU, registers, and other components. The one or more processors are configured to implement various software instructions. For example, the one or more processors are configured to execute instructions (e.g., software instructions 128) to perform the operations of the computing device 120 described herein. In this way, processor 122 may be a special-purpose computer designed to implement the functions disclosed herein. In an embodiment, the processor 122 is implemented using logic units, FPGAs, ASICs, DSPs, or any other suitable hardware. The processor 122 is configured to operate as described in FIGS. 1-3B. For example, the processor 122 may be configured to perform one or more operations of the operational flow 200 as described in FIG. 2, and one or more operations of the method 300 as described in FIGS. 3A and 3B.

Network interface 124 is configured to enable wired and/or wireless communications. The network interface 124 may be configured to communicate data between the computing device 120 and other devices, systems, or domains. For example, the network interface 124 may comprise an NFC interface, a Bluetooth interface, a Zigbee interface, a Z-wave interface, a radio-frequency identification (RFID) interface, a WIFI interface, a local area network (LAN) interface, a wide area network (WAN) interface, a metropolitan area network (MAN) interface, a personal area network (PAN) interface, a wireless PAN (WPAN) interface, a modem, a switch, and/or a router. The processor 122 may be configured to send and receive data using the network interface 124. The network interface 124 may be configured to use any suitable type of communication protocol.

The memory 126 may be a non-transitory computer-readable medium. The memory 126 may be volatile or non-volatile and may comprise read-only memory (ROM), random-access memory (RAM), ternary content-addressable memory (TCAM), dynamic random-access memory (DRAM), and/or static random-access memory (SRAM). The memory 126 may include one or more of a local database, a cloud database, a network-attached storage (NAS), etc. The memory 126 comprises one or more disks, tape drives, or solid-state drives, and may be used as an over-flow data storage device, to store programs when such programs are selected for execution, and to store instructions and data that are read during program execution. The memory 126 may store any of the information described in FIGS. 1-3B along with any other data, instructions, logic, rules, or code operable to implement the function(s) described herein when executed by processor 122. For example, the memory 126 may store software instructions 128, build platform 136, repositories 130a, 130b, and/or any other data or instructions described herein. The software instructions 128 may comprise any suitable set of instructions, logic, rules, or code operable to execute the processor 122 and perform the functions described herein, such as some or all of those described in FIGS. 1-3B.

The build platform 136 may be a software application platform where code may be developed. The build platform may provide an interface to users 102 to interact with the development environment. This interface allows users 102, such as software developers, to create, edit, and manage code for various software applications. The build platform 136 presents a collaborative workspace where development teams may work together on coding tasks, which makes it a part of the software development lifecycle.

Within the build platform 136, users 102 may access a range of development tools and features to the coding process. These tools may include code checkers, version control systems, debugging utilities, and integration with other software development technologies. Additionally, the build platform 136 may support various programming languages, frameworks, and libraries, providing flexibility to developers in choosing the technologies that best suit their application development tasks. When code is built within the build platform 136, the build process triggers the open-source management device 150 to scan for open-source software components when the request 106 is sent to the open-source management device 150.

### CVE Database

The Common Vulnerabilities and Exposures (CVE) database 140 may be any storage capacity structure that is configured to store data and communicate with other devices. Examples of the CVE database 140, include, but are not limited to, a network-attached storage cloud, a storage area network, a storage assembly directly (or indirectly) coupled to one or more components of the system 100. The CVE database 140 stores a list of open-source software components 142. The CVE database 140 may be a centralized database that collects and maintains records of security vulnerabilities, bugs, and other issues that have been identified in software and/or hardware applications/services over time. These vulnerabilities may range from code weaknesses and flaws to security issues that may be manipulated by malicious actors. Each entry in the CVE database 140 is assigned a unique identifier known as a CVE ID, which helps in recording and referencing the vulnerabilities.

Each entry in the CVE database 140 may include an open-source software component 142 associated with vulnerabilities 144 and other characteristics 146. The other characteristics 146 may include CVE ID, description, references, affected products (e.g., software applications, hardware, systems), vulnerability severity, publication data, and a solution, among other information associated with a respective open-source software component 142. The description may include details about the affected software or hardware, potential impact, and any relevant information about the respective open-source software component 142. The references may include sources of information where the vulnerability was detected, such as research papers, security patches, etc. The affected products may include information about software, hardware, or systems that are vulnerable to the identified issues, including the specific versions of the software, hardware, or systems. The vulnerability severity may provide the severity level of the vulnerability, such as low, medium, or high. The vulnerability severity may be determined based on the potential impact of the vulnerability. The publication date may indicate a date when the CVE entry was created or updated. The solution may include information about how to remedy or mitigate the vulnerability, such as security patches, workarounds, and configuration changes. The open-source management device 150 may use the information stored in the CVE database 140 to perform one or more of its operations described below.

### Open-Source Management Device

Open-source management device 150 may generally include any hardware computer system that is configured to scan code 134 (and/or compiled binary representation 132 of the code 134), detect open-source software components 162 in the code 134 (and/or in compiled binary representation 132 of the code 134), evaluate each open-source software component 162 to determine its characteristics, including permission factor 172, vulnerability factor 174, and temporal gap factor 176, assign rating to each of these characteristics, and mitigate the vulnerabilities associated with the open-source software component 162 that is determined to pose or introduce security threats to the software application associated with the source code 134, where the security threats outweigh the benefits of using the open-source software component 162. For example, mitigating the vulnerabilities associated with the open-source software component 162 may include recommending the most recent version of the open-source software component 162 that has a fewer number of vulnerabilities (e.g., the most recent version of the open-source software component 162 that has less than a threshold number 198 of vulnerabilities).

The open-source management device 150 includes a processor 152 operably coupled to a network interface 154 and a memory 156. The memory 156 stores software instructions 158 that when executed by the processor 152 cause the processor 152 to perform one or more operations of the open-source management device 150.

Processor 152 comprises one or more processors. The processor 152 is any electronic circuitry, including, but not limited to, state machines, one or more CPU chips, logic units, cores (e.g., a multi-core processor), FPGAs, ASICs, or DSPs. For example, one or more processors may be implemented in cloud devices, servers, virtual machines, and the like. The processor 152 may be a programmable logic device, a microcontroller, a microprocessor, or any suitable number and combination of the preceding. The one or more processors are configured to process data and may be implemented in hardware or software. For example, the processor 152 may be 8-bit, 16-bit, 32-bit, 64-bit, or of any other suitable architecture. The processor 152 may include an ALU for performing arithmetic and logic operations. The processor 152 may register the supply operands to the ALU and store the results of ALU operations. The processor 152 may further include a control unit that fetches instructions from memory and executes them by directing the coordinated operations of the ALU, registers, and other components. The one or more processors are configured to implement various software instructions. For example, the one or more processors are configured to execute instructions (e.g., software instructions 158) to perform the operations of the open-source management device 150 described herein. In this way, processor 152 may be a special-purpose computer designed to implement the functions disclosed herein. In an embodiment, the processor 152 is implemented using logic units, FPGAs, ASICs, DSPs, or any other suitable hardware. The processor 152 is configured to operate as described in FIGS. 1-3B. For example, the processor 152 may be configured to perform one or more operations of the operational flow 200 as described in FIG. 2 and one or more operations of the method 300 as described in FIGS. 3A and 3B.

Network interface 154 is configured to enable wired and/or wireless communications. The network interface 154 may be configured to communicate data between the open-source management device 150 and other devices, systems, or domains. For example, the network interface 154 may comprise an NFC interface, a Bluetooth interface, a Zigbee interface, a Z-wave interface, an RFID interface, a WIFI interface, a LAN interface, a WAN interface, a MAN interface, a PAN interface, a WPAN interface, a modem, a switch, and/or a router. The processor 152 may be configured to send and receive data using the network interface 154. The network interface 154 may be configured to use any suitable type of communication protocol.

The memory 156 may be a non-transitory computer-readable medium. The memory 156 may be volatile or non-volatile and may comprise ROM, RAM, TCAM, DRAM, and/or SRAM. The memory 156 may include one or more of a local database, a cloud database, a NAS, etc. The memory 156 comprises one or more disks, tape drives, or solid-state drives, and may be used as an over-flow data storage device, to store programs when such programs are selected for execution, and to store instructions and data that are read during program execution. The memory 156 may store any of the information described in FIGS. 1-3B along with any other data, instructions, logic, rules, or code operable to implement the function(s) described herein when executed by processor 152. For example, the memory 156 may store software instructions 158, code scanner 160, scan results 164, open-source software components 162, permission factor 172, vulnerability factor 174, temporal gap factor 176, permission score 186, vulnerability score 188, temporal gap score 190, recommended open-source software component 180, total score 194, threshold scores 192a-d, priority level 196, historical scans 184, threshold duration 182, algorithms 216a-d, confidence scores 214a-c, aggregated results 210, threshold number 198, message 226, and/or any other data or instructions. The software instructions 158 may comprise any suitable set of instructions, logic, rules, or code operable to execute the processor 152 and perform the functions described herein, such as some or all of those described in FIGS. 1-3B.

Code scanner 160 may be implemented by the processor 152 executing the software instructions 158, and is generally configured to scan source code 134 and compiled binary representation 132 of the source code 134. The code scanner 160 may be integrated into the software development life cycle to automatically be triggered when a new code is built to scan the code 134 and/or its compiled binary representation 132.

In some embodiments, the code scanner 160 may be implemented by a code scraper, code pattern recognition, text pattern recognition, and the like. For example, the code scanner 160 may employ these algorithms to search for code patterns and signatures that include characteristics of open-source software components 162. In some examples, these patterns may include unique identifiers, file names, folder names, library names, keywords, code function names, variable names, code components, comments, or specific code structures commonly found in open-source libraries or packages. In some examples, code scanner 160 may scan to detect clues associated with open-source software components 142, where the clues include a file name, a folder name, or a comment. The open-source software components 162 may include any open-source software component that is available to the public. Each open-source software component 162 may include certain functions to the overall software application.

In some embodiments, the code scanner 160 may evaluate dependency files to detect open-source software components 162. For example, the code scanner 160 may scan dependency files, such as requirements.txt, etc. to determine whether any external open-source library is used. In some embodiments, the code scanner 160 may use custom rules to detect open-source software components 162 that are not found in databases (e.g., CVE database 140) or to handle specific examples of code that are not detected through regular known open-source software component patterns. For example, the custom rules may include regular expressions to detect custom-built open-source software components 162.

Once the code scanner 160 scans the source code 134 (and/or the compiled binary representation 132 of the source code 134), the code scanner 160 may produce the scan results 164. The scan results 164 may include one or more open-source software components 162a, where each open-source software component 162a may be associated with the respective version 166a, permission 168a, and vulnerability 170a, among other information. The code scanner 160 may use this information to evaluate each open-source software component 1602a. This process is described below in conjunction with the description of FIG. 2.

Each algorithm 216a-d may be implemented by the processor 152 executing the software instructions 158 and is generally configured to evaluate the version 166a of a detected open-source software component 162a. Each algorithm 216a-c may provide information about various aspects of the version 166a of the detected open-source software component 162a. Details of the algorithms 216a-d are described below in the discussion of FIG. 2.

### Operational Flow for Detecting Open-Source Software Components in Source Code

FIG. 2 illustrates an example operational flow 200 of system 100 (see FIG. 1) for detecting open-source software components 162 in source code 134 (and/or in the compiled binary representation 132 of the source code 134). The operational flow 200 may begin when a new code (e.g., source code 134) is built in the build platform 136. For example, the user 102 may develop the source code 134 for a software application in the build platform 136 using the computing device 120, similar to that described in FIG. 1.

When the new source code 134 is built, the request 106 is sent to the open-source management device 150. The request 106 may include information related to a repository 130b where the source code 134 is available and information related to the repository 130a where the compiled binary representation 132 of the source code 134 is available. For example, the request 106 may include the links or paths to the source code 134 and the compiled binary representation 132 of the source code 134. The request 106 may indicate to determine whether the source code 134 includes any open-source software components 162 (e.g., to scan for the open-source software components 162).

Upon receiving the request 106, the request may arrive at the portal 202. The portal 202 may be an entry point or user interface that facilitates communication between users and the open source management device 150. For example, the portal 202 may be or associated with a monitor, network interface 154, etc. The open-source management device 150 may forward the request 106 to the code scanner 160. The code scanner 160 may determine which portion of the source code 134 has not been scanned in a past threshold duration 182. The past threshold duration 182 may be one day, two days, one week, or any other suitable duration. Each portion of the source code 134 may be one or more lines of code, a library, a package, or any content included in or associated with the source code 134.

For example, the code scanner 160 may access the source code 134 and determine which portion(s) of the source code 134 have been scanned in the past threshold duration 182 and which portion(s) have not been scanned in the past threshold duration 182. In this process, the code scanner 160 may access the historical scans 184 associated with the source code 134 and other code, identify the timestamp of scan of each portion of the source code 134 (if any), and for each portion of the source code 134, perform a comparison between the information associated with the historical scans 184 and each portion of the source code 134 to identify which portions of the source code 134 have not been scanned within the past threshold duration 182. This process avoids redundant scans of code that have been recently scanned for open-source software components 162 and increases the scanning resources utilization.

If it is determined that a portion of the source code 134 was scanned within the past threshold duration 182, the code scanner 160 may not scan the determined portion of the source code 134. Otherwise, if it is determined that a portion of the source code 134 was not scanned within the past threshold duration 182, the code scanner 160 may scan the determined portion of the source code 134. For example, assume that the code scanner 160 determines that a first portion 212 of the source code 134 has not been scanned for the past threshold duration 182 based on the timestamps of historical scans 184. In response, the code scanner 160 may obtain the determined portion 212 of the source code 134 from the repository 132. In this process, the code scanner 160 may use the link to the repository 130b and download the identified portion 212 of the source code 134. In some embodiments, the code scanner 160 may also use the link to the repository 130a and download the respective portion 212 of the compiled binary representation 132 of the source code 134.

Scanning a Portion of the Source Code and/or a Compiled Binary Representation of the Source Code

The code scanner 160 may determine whether to scan the identified portion 212 of the source code 134 and/or the corresponding portion 212 from the compiled binary representation 132 of the source code 134 based on a priority level 196 of the software application development associated with the source code 134. In some embodiments, the code scanner 160 may receive the priority level 196 from the user 102.

As mentioned above, scanning the source code 134 is computationally intensive. Therefore, the code scanner 160 may scan the portion 212 of the source code 134 and the corresponding portion 212 in the compiled binary representation 132 of the source code 134, if it is determined that the priority level 196 of the software application development associated with the source code 134 is high (e.g., more than a threshold number, such as 7, on a scale of 1 to 10), If it is determined that the priority level 196 of the software application development associated with the source code 134 is medium (e.g., between 4 to 7 on a scale of 1 to 10), the code scanner 160 may only scan the portion 212 of the source code 134. If it is determined that the priority level 196 of the software application development associated with the source code 134 is low (e.g., less than 4 on a scale of 1 to 10), the code scanner 160 may only scan the portion 212 of the compiled binary representation 132 of the source code 134.

In the example of FIG. 2, assume that the code scanner 160 scans the portion 212 of the source code 134 in response to determining that the priority level 196 of the software development associated with the source code 134 is high. In this process, the code scanner 160 may scan the portion 212 of the source code 134 to identify code patterns associated with the open-source software components 142 that may be used in the portion 212 of the source code 134, and other information associated with the open-source software components 142, similar to that described in FIG. 1.

The code scanner 160 may cross-reference between the code patterns associated with the open-source software components 142 and code patterns associated with the portion 212 of the source code 134. The code scanner 160 may employ various techniques to identify potential open-source software components 142 within the portion 212 of the source code 134. For example, the code scanner 160 may search for specific keywords, function names, library references associated with open-source software components 142. In another example, the code scanner 160 may search for patterns and coding conventions used in open-source software components 142 and identify code segments that correspond to structures found in open-source software components 142. In another example, the code scanner 160 may search for application programming interface (API) calls to open-source software components 142. The code scanner 160 may implement any other technique to detect the open-source software components 142 in the portion 212 of the source code 134.

In this process, the code scanner 160 may compare the portion 212 of the source code 134 with each CVE entry in the CVE database 140 and determine whether any part of the portion 212 of the source code 134 corresponds to the code pattern associated with the open-source software component 142. For example, the code scanner 160 may employ a pattern recognition machine learning algorithm to perform this operation. If it is determined that a part of the portion 212 of the source code 134 corresponds to the code pattern associated with the open-source software component 142, the code scanner 160 may determine that the open-source software component 142 is used in the portion 212 of the source code 134 (as open-source software component 162a). The code scanner 160 may perform similar operations for each part of the portion 212 of the source code 134. For brevity, the similar operations are not repeated, but it would be understood that similar operations may lead to detecting the open-source software component 162b in the portion 212 of the source code 134. The operations below are described with respect to the open-source software component 162a, but it would be understood and similar operations may also apply to the open-source software component 162b.

### Evaluating an Open-Source Software Component

For example, assume that the code scanner 160 has detected that the open-source software component 162a is used in the portion 212 of the source code 134. In this example, the code scanner 160 has determined that the open-source software component 162a corresponds to one of the CVE entries as an open-source software component 142 in the CVE database 140. In response, the code scanner 160 may retrieve information associated with the detected open-source software component 162a, where the information includes a version 166a, a permission 168a, and vulnerability 170a associated with the open-source software component 162a. In some embodiments, the code scanner 160 may retrieve this information from the CVE entry associated with the open-source software component 162a from the CVE database 140. In other words, by the virtue of determining the identity of the open-source software component 162a, the code scanner 160 may be able to access and fetch information about the open-source software component 162a (e.g., version 166a, a permission 168a, and vulnerability 170a) from the CVE database 140. The code scanner 160 may source this information from various repositories, with one common source being the CVE database 140. The CVE entry associated with the open-source software component 162a within the CVE database 140 may provide a record of the version 166a, a permission 168a, and vulnerability 170a of the open-source software component 162a. The code scanner 160 may use this information to evaluate the security threat of using the open-source software component 162a.

The code scanner 160 may produce the scan result 164 that includes the information about the detected open-source software component 162a, version 166a, permission 168a, and vulnerability 170a of the open-source software component 162a. In some embodiments, other sources and scanners may also provide additional relative information about the detected open-source software component 162 to the open-source management device 150. In some embodiments, additional information related to the detected open-source software component 162a may be provided by user manual entry to the open-source management device 150. The provided information from other sources, scanners, and manual entry may be aggregated with the scan results 164 to produce the aggregated results 210.

The code scanner 160, based on the aggregated results 210, may determine at least three factors about the open-source software component 162a. In some embodiments, the three factors include the permission factor 172, the vulnerability factor 174, and the temporal gap factor 176.

### Determining the Permission and Vulnerability Factors

The code scanner 160, based on the identity of the open-source software component 162a, may determine the permission factor 172 associated with the open-source software component 162a. The permission factor 172 may include the permission terms, restrictions, and conditions of the open-source software component 162a. In response, the code scanner 160 may determine whether there are any terms and restrictions for distributing the open-source software component 162a to third-party software applications or deploying the open-source software component 162a in software applications where it would be distributed to the public. In response, the code scanner 160 may assign a permission score 186 to the permission factor 172 based on the restrictions associated with the permission of the open-source software component 162a. The permission score 186 may indicate a permission threat level for implementing the open-source software component 162a in the source code 134.

For example, if the code scanner 160 determines that the permission of the open-source software component 162a restricts using the open-source software component 162a in third-party software applications or deploying the open-source software component 162a in software applications where it would be distributed to the public, the code scanner 160 may assign a high permission score 186 to the permission factor 172. For example, a high permission score 186 may be more than a first threshold score 192a, such as more than 7 out of 10.

The code scanner 160, based on the identity of the open-source software component 162a, may determine the vulnerability factor 174 associated with the open-source software component 162a. In this process, the code scanner 160 may access the CVE entries in the CVE database 140, where each CVE entry includes an open-source software component 142 associated with a respective set of security vulnerabilities. The code scanner 160 may compare the open-source software component 162a with each of the open-source software components 142 and determine the open-source software component 162a corresponds to which open-source software component 142, similar to that described above. For example, assume that the code scanner 160 determines that open-source software component 162a corresponds to a first open-source software component 142. In response, the code scanner 160 may determine that the open-source software component 162a is associated with the first set of security vulnerabilities 170a to which the first open-source software component 142 is associated. In response, the code scanner 160, based on the identity of the open-source software component 162a, 142 and the first set of security vulnerabilities 170a, assigns the vulnerability factor 174 for the open-source software component 162a, where the vulnerability factor 174 indicates the first set of security vulnerabilities 170a.

The code scanner 160 may assign a vulnerability score 188 to the vulnerability factor 174, where the vulnerability score 188 may indicate a vulnerability security threat of implementing the open-source software component in the source code 134. The code scanner 160 may assign a low, medium, or high vulnerability score 188 to the vulnerability factor 174. For example, the code scanner 160 may assign a high vulnerability score 188 (e.g., more than 7 out of 10) to the vulnerability factor 174 if the severity of the vulnerabilities 170a is indicated to be high in the respective CVE entry in the CVE database 140. In other words, in such cases, the code scanner 160 may assign a high vulnerability score 188 to the vulnerability factor 174, where the vulnerability score 188 may indicate that the vulnerability security threat of implementing the open-source software component 162a in the source code 134 is more than a second threshold score 192b (e.g., more than 7 out of 10). In another example, the code scanner 160 may assign a medium vulnerability score 188 (e.g., between 4 and 7 out of 10) to the vulnerability factor 174 if the severity of the vulnerabilities 170a is indicated to be medium in the respective CVE entry in the CVE database 140. In another example, the code scanner 160 may assign a low vulnerability score 188 (e.g., less than 4 out of 10) to the vulnerability factor 174 if the severity of the vulnerabilities 170a is indicated to be low in the respective CVE entry in the CVE database 140.

### Determining the Temporal Gap Factor

The temporal gap factor 176 may indicate how far behind the version 166a of the open-source software component 162a is with respect to the latest version of the open-source software component 162a. The temporal gap factor 174 may be determined based on various algorithms 216a-c. The first algorithm 216a may determine and provide information indicating numerically how many versions the open-source software component 162a in use is behind its latest version. The first algorithm 216a may provide a numerical value that indicates the version gap between the currently used version and the most recent version of the open-source software component 162a. For example, if the latest version of the open-source software component 162a is 5.3 (as indicated in the respective CVE entry in the CVE database 140) and the open-source software component 162a in use is version 2.1. The algorithm 216a may assign a numerical value of 2 to represent that open-source software component 162a is three versions behind its latest version.

The second algorithm 216b may provide more detailed and robust information of the version gap for the open-source software component 162a. The second algorithm 216b distinguishes between major and minor version differences. Major versions often include significant changes or updates, while minor versions typically consist of smaller updates or bug fixes. More specifically, the second algorithm 216b may indicate how many minor versions and how many major versions, the open-source software component 162a is behind its latest version. For instance, if the latest version of the open-source software component 162a is 5.3 (as indicated in the respective CVE entry in the CVE database 140) and the open-source software component 162a in use is version 5.1. The algorithm 216b may determine that the open-source software component 162a is no major version and two minor versions behind its latest version.

The third algorithm 216c may provide information about the time aspect of the version gaps. The third algorithm 216c may determine the duration or time span between the release date of the latest version of the open-source software component 162a and the version currently in use. This information provides insights into how long the component has remained without an update. For example, the third algorithm 216c may indicate the date span that the open-source software component 162a in use is behind its latest version release date. For example, if the latest version of the open-source software component 162a was released in January 2023 and the open-source software component 162a in use dates back to July 2021, the algorithm 216c may report that the open-source software component 162a is approximately 1.5 years behind in terms of release date.

Each of the algorithms 216a-c may provide a respective temporal gap factor 176 based on the quantity of data points that it uses. Based on the number of data points used by each algorithm 216a-c, the open-source management device 150 may assign a confidence score 224a-c to the respective algorithm 216a-c. For example, the open-source management device 150 may assign a confidence score 224a to an algorithm 216a-c that is proportional to the number of data points used by the respective algorithm 216a-c. In some examples, the data points may include the number of changes in the versions, number of major version changes, number of minor version changes, and release dates, among others. In this way, the open-source management device 150 may scale the reliability and accuracy of each algorithm 216a-c by considering the quantity and quality of the data points they utilize. This allows the temporal gap factor 174 to provide a meaningful and precise evaluation of the open-source software component's version. The code scanner 160 may select the temporal gap factor 176 that is determined based on an algorithm 216a-c that is associated with the highest confidence level 224a-c. The code scanner 160 may assign the temporal gap score 190 to the temporal gap factor 176. The temporal gap factor 176 may indicate whether the security threat (related to being outdated) for implementing the open-source software component 162a in the source code 134 is more than a third threshold score 192c (e.g., more than 7 out of 10).

The code scanner 160 may use assigned temporal gap score 190 along with the permission score 186 and vulnerability score 188 to calculate the total score 194. The total score 194 may be the combined (e.g., addition of) the temporal gap score 190, permission score 186, and vulnerability score 188. In some embodiments, the code scanner 160 may assign a higher weight to the temporal gap factor 176 compared to permission factor 172 and vulnerability factor 174 because temporal gap factor 176 provides more accurate information about the security threat posed by the open-source software component 162a compared to the other factors. In such embodiments, the total score 194 may be a weighted score of the temporal gap score 190, permission score 186, and vulnerability score 188.

The code scanner 160 may compare the total score 194 with the threshold score 192d (e.g., 27 out 30, or other ranges or scales). In some embodiments, if the total score 194 is more than the threshold score 192d, the code scanner 160 may determine that the security threats of implementing the open-source software component 162a outweigh its benefits. In response, the code scanner 160 may identify another version of the open-source software component 162a to be used. For example, the code scanner 160 may identify the most recent version of the open-source software component 162a that is associated with less than a threshold number of security vulnerabilities (e.g., less than one, two, three, etc. security vulnerabilities). In the same or another example, the code scanner 160 may identify the most recent version of the open-source software component 162a that is associated with a fewer number of security vulnerabilities. The code scanner 160 may identify this information from the CVE database 140. For example, the code scanner 160 may access the CVE entries and identify the version of the open-source software component 162a with the lowest vulnerability count or with less than the threshold number 198 of vulnerabilities. Alternatively, in some embodiments, the code scanner 160 may recommend a different open-source software component 142, 162 with similar functionality but with a better security profile (e.g., with fewer security vulnerabilities) if available.

In some embodiments, in response to identifying the recommended open-source software component 180, the code scanner 160 may provide the recommended open-source software component 180 to the user 102. The user 102 may approve or deny the recommended open-source software component 180. In some embodiments, if the user 102 approves the recommended open-source software component 180, it may be implemented in the production of the software application associated with the source code 134.

In some embodiments, the open-source management device 150 may perform a policy compliance check 220. The policy compliance check 220 facilitates that the decision to use the recommended open-source software component 180 aligns with the policies and guidelines set by the organization or authorities overseeing the software development process. In this process, the open-source management device 150 may determine whether authorities have approved using the recommended open-source software component 180 (or the open-source software component 162a, in case the user 102 does not approve the recommended open-source software component 180). For example, the user feedback on approving or denying the recommended open-source software component 180 may be sent to authorities who are at a higher level in the software development team. This additional layer of review helps ensure that decisions regarding open-source software component usage are in line with organizational policies and standards, and provides an added layer of security and compliance.

In some embodiments, the open-source management device 150 may only consider the temporal gap factor 176 for evaluating the security threat posed by the detected open-source software component 162a. In such embodiments, if the open-source management device 150 determines that the temporal gap score 190 is more than the threshold score 192c, the open-source management device 150 may proceed to identify the most recent version of the open-source software component 162a associated with a fewer number of security vulnerabilities (e.g., associated with less than a threshold number of security vulnerabilities), recommend to use the recommended open-source software component 180 to the user 102 via the message 226, if the user 102 approves the system's recommendation (indicated by the approval message 222), implement the recommended open-source software component 180 in the production of the software application associated with the source code 134.

Example Method for Mitigating Vulnerabilities Associated with Open-Source Software Components in Source Code

FIGS. 3A and 3B illustrate an example flowchart of a method 300 for mitigating vulnerabilities associated with open-source software components 162 in source code 134, according to some embodiments. Modifications, additions, or omissions may be made to method 300. Method 300 may include more, fewer, or other operations. For example, operations may be performed in parallel or in any suitable order. While at times it is discussed that the system 100, computing devices 120, open-source management device 150, or components of any of thereof perform some operations, any suitable system or components of the system may perform one or more operations of the method 300. For example, one or more operations of method 300 may be implemented, at least in part, in the form of software instructions 128 and 158 of FIG. 1, stored on a tangible non-transitory machine-readable medium (e.g., memory 126 and 156 of FIG. 1) that when run by one or more processors (e.g., processor 122 and 152 of FIG. 1) may cause the one or more processors to perform operations 302-320.

At operation 302, the open-source management device 150 receives a request 106 to determine whether source code 134 comprises any open-source software components 142, 162, where the request 106 comprises information related to a repository 130b where the source code 134 is available and stored. In some embodiments, the request 106 may further include information about the repository 130a where the compiled binary representation 132 of the source code 134 is stored. The open-source management device 150 may then determine whether any portion of the source code 134 and/or any portion of compiled binary representation 132 of the source code 134 has not been scanned for the past threshold duration 182, similar to that described in FIGS. 1 and 2. For example, the open-source management device 150 may access the historical scans 184 associated with one or more source code 134, one or more compiled binary representations 132 of various source code 134, where each historical scan 184 is associated with a timestamp when a respective open-source management device 150, source code 134, and/or compiled binary representation 132 was scanned. The open-source management device 150 may examine each line of the source code 134 and/or each line of the compiled binary representation 132 of the source code 134 and compare them with the code and/or compiled binary representation that were scanned as indicated by the historical scans 184. Based on this information, the open-source management device 150 may determine which portion(s) of the source code 134 and/or portion(s) of the compiled binary representation 132 have not been scanned for the past threshold duration 182.

At operation 304, the open-source management device 150 determines that a first portion 212 of the source code 134 has not been scanned for the past threshold duration 182. At operation 306, the open-source management device 150 determines to scan the first portion of the source code 134 instead of the compiled binary representation 132 of the source code 134 based on the priority level 196 of the software application associated with the source code 134, similar to that described in FIG. 2.

At operation 308, the open-source management device 150 obtains the first portion 212 of the source code 134 from the repository 130b. For example, the open-source management device 150 may download the first portion 212 from the repository 130b.

At operation 310, the open-source management device 150 scans the first portion 212 of the source code 134. For example, the open-source management device 150 may feed the first portion 212 of the source code 134 to the code scanner 160 and the code scanner 160 may implement code pattern recognition, keyword search, and other algorithms to determine whether any open-source software component is present in the first portion 212 of the source code 134, similar to that described in FIG. 2.

At operation 312, the open-source management device 150 determines the identity of the open-source software component 142, 162 in the first portion 212 of the source code 134. For example, the open-source management device 150 may compare each part (e.g., line) of the first portion 212 of the source code 134 with each open-source software component 142 from the CVE database 140. In this comparison, the open-source management device 150 may translate each element (e.g., word) of the first portion 212 into a first feature vector that comprises numbers, translate each element (word) of a first open-source software component 142 into a second feature vector that comprises numbers, and compare the first feature vector with the second feature vector. If it is determined that the first feature vector corresponds to the second feature vector, the open-source management device 150 may determine that the portion 212 of the source code 134 corresponds to at least the first open-source software component 142. The open-source management device 150 may perform a similar operation for other open-source software components 142.

At operation 314, the open-source management device 150 determines a set of factor associated with the open-source software component 162, where the set of factors includes a permission factor 172, a vulnerability factor 174, and a temporal gap factor 176, similar to that described in FIG. 2. At operation 316, the open-source management device 150 assigns a score to each of the set of factors. For example, the open-source management device 150 may assign the permission score 186 to the permission factor 172, the vulnerability score 188 to the vulnerability factor 174, and the temporal gap score 190 to the temporal gap factor 176, similar to that described in FIG. 2.

In FIG. 3B, at operation 318, the open-source management device 150 determines a combined score 194 by combining the set of scores 186, 188, and 190, where the combined score 194 may represent a security threat of implementing the open-source software component 162. At operation 320, the open-source management device 150 determines whether the combined score 194 is more than a threshold score 192d. If it is determined that the combined score 194 is more than the threshold score 192d, the method 300 proceeds to operation 326. Otherwise, the method 300 proceeds to operation 322.

At operation 322, the open-source management device 150 determines that the current version of the open-source software component 162 that is in use is safe to be pushed to production of the software application associated with the source code 134. In other words, the open-source management device 150 may determine that the security threat posed by the open-source software component 162 is less than an acceptable threshold (e.g., less than 50%, 40%, etc.). At operation 324, the open-source management device 150 deploys the current version of the open-source software component 162 to the production of the software application. In other words, the open-source management device 150 may allow the user 102 to implement the current version of the open-source software component 162 that they initially used in the source code 134.

At operation 326, the open-source management device 150 identifies the most recent version of the open-source software component 162 that is associated with a less than a threshold number of security vulnerabilities (e.g., most recent version of the open-source software component 162 that is associated a fewer number of security vulnerabilities).

At operation 328, the open-source management device 150 recommends to use the identified version of the open-source software component. For example, the open-source management device 150 may send a message that includes the initial version of the open-source software component 162 and the recommended open-source software component 180 to the computing device 120.

At operation 330, the open-source management device 150 receives an approval message 222 that indicates that the recommendation is approved. For example, the open-source management device 150 may receive, from the computing device 120, the approval message 222 when the user 102 approves using the recommended open-source software component 180.

At operation 332, the open-source management device 150 deploys the identified version of the open-source software component 180 in the source code 134.

While several embodiments have been provided in the present disclosure, it should be understood that the system 100 and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted, or not implemented. In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein. To aid the Patent Office, and any readers of any patent issued on this application in interpreting the claims appended hereto, applicants note that they do not intend any of the appended claims to invoke 35 U.S.C. § 112 (f) as it exists on the date of filing hereof unless the words “means for” or “step for” are explicitly used in the particular claim.

1. A system for mitigating vulnerabilities associated with open-source software components in source code, comprising:
a memory configured to store a list of open-source software components; and
a processor, operably coupled to the memory, and configured to:
receive a request to determine whether source code comprises any open-source software components, wherein the request comprises information related to a repository where the source code is available;
determine that a first portion of the source code has not been scanned for a past threshold duration;
in response to determining that the first portion of the source code has not been scanned for the past threshold duration, obtain the first portion of the source code from the repository;
scan the first portion of the source code, wherein scanning the first portion of the source code comprising identifying one or more code patterns associated with an open-source software component from among the list of open-source software components;
determine, based at least in part upon an identity of the open-source software component, a software version of the open-source software component;
determine, based at least in part upon the determined software version of the open-source software component, a temporal gap factor associated with the open-source software component, wherein the temporal gap factor indicates how far behind the software version of the open-source software component is with respect to a latest software version of the open-source software component;
assign a temporal gap score to the temporal gap factor, wherein the temporal gap score indicates whether a threat of implementing the open-source software component into the source code is more than a first threshold score;
determine that the assigned temporal gap score is more than the first threshold score; and
in response to determining that the temporal gap score is more than the first threshold score:
identify a most recent version of the open-source software component that is associated with a less than a threshold number of security vulnerabilities; and
implement the identified most recent version of the open-source software component in the source code.

2. The system of claim 1, wherein the processor is further configured to:
determine, based at least in part upon the identity of the open-source software component, a permission factor associated with the open-source software component;
determine, based at least in part upon the determined permission factor, a restriction for distributing the open-source software component to a third-party software application; and
in response to determining the restriction, assign a permission score to the permission factor, wherein the permission score indicates that a threat of implementing the open-source software component in the source code is more than a second threshold score.

3. The system of claim 2, wherein the processor is further configured to:
access a vulnerability database that comprises the list of open-source software components, wherein each of the open-source software components is associated with a respective set of security vulnerabilities;
compare the open-source software component with each of the open-source software components in the vulnerability database;
determine that the open-source software component is associated with a first set of security vulnerabilities;
determine, based at least in the identity of the open-source software component and the first set of security vulnerabilities, a vulnerability factor associated with the open-source software component, wherein the vulnerability factor indicates the first set of security vulnerabilities;
assign, based at least in part upon the determined vulnerability factor, a vulnerability score to the vulnerability factor, wherein the vulnerability score indicates that a threat of implementing the open-source software component in the source code is more than a third threshold score;
determine a combined score based at least in part upon the temporal gap score, the permission score, and the vulnerability score; and
determine that the combined score is more than a fourth threshold score.

4. The system of claim 3, wherein identifying the most recent version of the open-source software component that is associated with less than the threshold number of security vulnerabilities is further in response to determining that the combined score is more than the fourth threshold score.

5. The system of claim 1, wherein implementing the identified most recent version of the open-source software component in the source code is in response to receiving an indication that the identified most recent version of the open-source software component is approved.

6. The system of claim 1, wherein scanning the first portion of the source code further comprises detecting at least one clue associated with the open-source software component, wherein the at least one clue comprises a file name, a folder name, or a comment within the first portion of the source code.

7. The system of claim 1, wherein determining that the first portion of the source code has not been scanned for the past threshold duration is in response to:
accessing a set of historical scans associated with the open-source software components, wherein each of the set of historical scans is associated with a timestamp when a respective open-source software component was scanned; and
determining, based at least on the set of historical scans, that the first portion of the source code corresponds to a first open-source software component that has not been scanned for the past threshold duration.

8. A method for mitigating vulnerabilities associated with open-source software components in source code, comprising:
storing a list of open-source software components;
receiving a request to determine whether source code comprises any open-source software components, wherein the request comprises information related to a repository where the source code is available;
determining that a first portion of the source code has not been scanned for a past threshold duration;
in response to determining that the first portion of the source code has not been scanned for the past threshold duration, obtaining the first portion of the source code from the repository;
scanning the first portion of the source code, wherein scanning the first portion of the source code comprising identifying one or more code patterns associated with an open-source software component from among the list of open-source software components;
determining, based at least in part upon an identity of the open-source software component, a software version of the open-source software component;
determining, based at least in part upon the determined software version of the open-source software component, a temporal gap factor associated with the open-source software component, wherein the temporal gap factor indicates how far behind the software version of the open-source software component is with respect to a latest software version of the open-source software component;
assigning a temporal gap score to the temporal gap factor, wherein the temporal gap score indicates whether a threat of implementing the open-source software component into the source code is more than a first threshold score;
determining that the assigned temporal gap score is more than the first threshold score; and
in response to determining that the temporal gap score is more than the first threshold score:
identifying a most recent version of the open-source software component that is associated with a less than a threshold number of security vulnerabilities; and
implementing the identified most recent version of the open-source software component in the source code.

9. The method of claim 8, further comprising:
determining, based at least in part upon the identity of the open-source software component, a permission factor associated with the open-source software component;
determining, based at least in part upon the determined permission factor, a restriction for distributing the open-source software component to a third-party software application; and
in response to determining the restriction, assigning a permission score to the permission factor, wherein the permission score indicates that a threat of implementing the open-source software component in the source code is more than a second threshold score.

10. The method of claim 9, further comprising:
accessing a vulnerability database that comprises the list of open-source software components, wherein each of the open-source software components is associated with a respective set of security vulnerabilities;
comparing the open-source software component with each of the open-source software components in the vulnerability database;
determining that the open-source software component is associated with a first set of security vulnerabilities;
determining, based at least in the identity of the open-source software component and the first set of security vulnerabilities, a vulnerability factor associated with the open-source software component, wherein the vulnerability factor indicates the first set of security vulnerabilities;
assigning, based at least in part upon the determined vulnerability factor, a vulnerability score to the vulnerability factor, wherein the vulnerability score indicates that a threat of implementing the open-source software component in the source code is more than a third threshold score;
determining a combined score based at least in part upon the temporal gap score, the permission score, and the vulnerability score; and
determining that the combined score is more than a fourth threshold score.

11. The method of claim 10, wherein identifying the most recent version of the open-source software component that is associated with less than the threshold number of security vulnerabilities is further in response to determining that the combined score is more than the fourth threshold score.

12. The method of claim 8, wherein implementing the identified most recent version of the open-source software component in the source code is in response to receiving an indication that the identified most recent version of the open-source software component is approved.

13. The method of claim 8, wherein scanning the first portion of the source code further comprises detecting at least one clue associated with the open-source software component, wherein the at least one clue comprises a file name, a folder name, or a comment within the first portion of the source code.

14. The method of claim 8, wherein determining that the first portion of the source code has not been scanned for the past threshold duration is in response to:
accessing a set of historical scans associated with the open-source software components, wherein each of the set of historical scans is associated with a timestamp when a respective open-source software component was scanned; and
determining, based at least on the set of historical scans, that the first portion of the source code corresponds to a first open-source software component that has not been scanned for the past threshold duration.

15. A non-transitory computer-readable medium storing instructions that when executed by a processor, cause the processor to:
store a list of open-source software components;
receive a request to determine whether source code comprises any open-source software components, wherein the request comprises information related to a repository where the source code is available;
determine that a first portion of the source code has not been scanned for a past threshold duration;
in response to determining that the first portion of the source code has not been scanned for the past threshold duration, obtain the first portion of the source code from the repository;
scan the first portion of the source code, wherein scanning the first portion of the source code comprising identifying one or more code patterns associated with an open-source software component from among the list of open-source software components;
determine, based at least in part upon an identity of the open-source software component, a software version of the open-source software component;
determine, based at least in part upon the determined software version of the open-source software component, a temporal gap factor associated with the open-source software component, wherein the temporal gap factor indicates how far behind the software version of the open-source software component is with respect to a latest software version of the open-source software component;
assign a temporal gap score to the temporal gap factor, wherein the temporal gap score indicates whether a threat of implementing the open-source software component into the source code is more than a first threshold score;
determine that the assigned temporal gap score is more than the first threshold score; and
in response to determining that the temporal gap score is more than the first threshold score:
identify a most recent version of the open-source software component that is associated with a less than a threshold number of security vulnerabilities; and
implement the identified most recent version of the open-source software component in the source code.

16. The non-transitory computer-readable medium of claim 15, wherein the instructions further cause the processor to:
determine, based at least in part upon the identity of the open-source software component, a permission factor associated with the open-source software component;
determine, based at least in part upon the determined permission factor, a restriction for distributing the open-source software component to a third-party software application; and
in response to determining the restriction, assign a permission score to the permission factor, wherein the permission score indicates that a threat of implementing the open-source software component in the source code is more than a second threshold score.

17. The non-transitory computer-readable medium of claim 16, wherein the instructions further cause the processor to:
access a vulnerability database that comprises the list of open-source software components, wherein each of the open-source software components is associated with a respective set of security vulnerabilities;
compare the open-source software component with each of the open-source software components in the vulnerability database;
determine that the open-source software component is associated with a first set of security vulnerabilities;
determine, based at least in the identity of the open-source software component and the first set of security vulnerabilities, a vulnerability factor associated with the open-source software component, wherein the vulnerability factor indicates the first set of security vulnerabilities;
assign, based at least in part upon the determined vulnerability factor, a vulnerability score to the vulnerability factor, wherein the vulnerability score indicates that a threat of implementing the open-source software component in the source code is more than a third threshold score;
determine a combined score based at least in part upon the temporal gap score, the permission score, and the vulnerability score; and
determine that the combined score is more than a fourth threshold score.

18. The non-transitory computer-readable medium of claim 17, wherein identifying the most recent version of the open-source software component that is associated with less than the threshold number of security vulnerabilities is further in response to determining that the combined score is more than the fourth threshold score.

19. The non-transitory computer-readable medium of claim 15, wherein implementing the identified most recent version of the open-source software component in the source code is in response to receiving an indication that the identified most recent version of the open-source software component is approved.

20. The non-transitory computer-readable medium of claim 15, wherein scanning the first portion of the source code further comprises detecting at least one clue associated with the open-source software component, wherein the at least one clue comprises a file name, a folder name, or a comment within the first portion of the source code.
